(19) United States
(12) Patent Application Publication
(10) Pub. No.: US 2011/0295966 A1
(43) Pub. Date: Dec. 1, 2011

(54) METHODS, SYSTEMS, AND COMPUTER PROGRAM PRODUCTS FOR PROCESSING A COMBINED COMMAND RESPONSE BASED ON A MARKUP ELEMENT

(76) Inventor: Robert Paul Morris, Raleigh, NC (US)

(21) Appl. No.: 12/789,568

(22) Filed: May 28, 2010

(51) Int. Cl. G06F 15/16; G06F 17/00

(52) U.S. Cl. 709/207; 709/218; 715/205

(57) ABSTRACT

Methods and systems are described for processing a combined command response based on a markup element. In one aspect, a resource is sent including a markup element identifying combine-request information. The combine-request information is received in a first request message identifying a first command. A second request message is received identifying a second command. A first response to the first command is determined to be combinable. In response, a combined response message is sent including a second response to the second command and the first response.

In another aspect, a resource is received including a markup element. Combine-request information based on the markup element is sent in a first request message identifying a first command based on the resource. A second message identifying a second command is sent. A combined response message is received including a first response for the first command and a second response for the second command.

### RELATED APPLICATIONS

This application is related to the following commonly owned U.S. patent applications, the entire disclosure of each being incorporated by reference herein: application Ser. No. 12/788,364 (Docket No 0103) filed on 2010 May 27, entitled “Methods, Systems, and Program Products for Processing an Attached Command Response”;

application Ser. No. 12/788,373 (Docket No 0131) filed on 2010 May 27, entitled “Methods, Systems, and Program Products for Preventing Processing of an HTTP Response”;

application Ser. No. ______, (Docket No 0147) filed on 2010 May 28, entitled “Methods, Systems, and Program Products for Processing an Attached Command Response Based on a Markup Element”;

application Ser. No. ______, (Docket No 0148) filed on 2010 May 28, entitled “Methods, Systems, and Program Products for Processing a Non-returnable Command Response Based on a Markup Element”; and

application Ser. No. 12/788,381 (Docket No 0150) filed on 2010 May 27, entitled “Methods, Systems, and Program Products for Processing a Combined Command Response”.

### BACKGROUND

The protocol of the Web, Hypertext Transfer Protocol (HTTP), is a request/response protocol. Browser markup languages, such as hypertext markup language (HTML), are designed to work with the request/response model of HTTP. More particularly, for each HTTP request there is a single HTTP response, unless an error occurs preventing generation and/or return of the response to the requesting user agent. HTTP requests and HTTP responses are communicated over a network connection. Multiple pairs of HTTP request and HTTP response messages can be exchanged over a single connection. HTTP responses must be returned via the connection in the order that their corresponding HTTP requests were exchanged via the connection.

An HTTP request that takes a relatively long time to perform or process by a server holds up HTTP responses to any HTTP requests received afterwards. Depending on the implementation of a particular server, the long-running HTTP request can prevent the particular server from beginning to perform commands identified in any later sent HTTP requests.

HTTP is used by web browsers that interact with people. Delays in responding can be frustrating to people. This frustration may be costly to website providers as users sometimes resubmit requests, wasting the resources of a service provider. Possibly worse, some users move on to another service provider or other activity.

The issues discussed above are exemplary issues associated with the current request/response model of the Web. Accordingly, there exists a need for methods, systems, and computer program products for processing a combined command response based on a markup element.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for processing a combined command response based on a markup element. In one aspect, the method includes sending, via a network to a user agent node, a first resource including a first combine markup element defined for identifying first combine-request information for a first command identified based on the first resource. The method further includes receiving, in response to sending the first resource, the first combine-request information in a first request message identifying the first command. The method still further includes receiving a second request message identifying a second command. The method additionally includes determining that a first command response to the first command is combinable based on the first combine-request. The method also includes, sending, in response to determining that the first command response is combinable, a combined response message including the first command response, in response to the first command, and including a second command response, in response to the second command.

Further, a system for processing a combined command response based on a markup element is described. The system includes an execution environment including an instruction-processing unit configured to process an instruction included in at least one of a resource generator component, a request-in component, a combine director component, and a response-out component. The system includes the resource generator component configured for sending, via a network to a user agent node, a first resource including a first combine markup element defined for identifying first combine-request information for a first command identified based on the first resource. The system further includes the request-in component configured for receiving, in response to sending the first resource, the first combine-request information in a first request message identifying the first command. The system still further includes the request-in component configured for receiving a second request message identifying a second command. The system also includes the combine director component configured for determining that a first command response to the first command is combinable based on the first combine-request. The system additionally includes the response-out component configured for sending, in response to determining that the first command response is combinable, a combined response message including the first command response, in response to the first command, and including a second command response, in response to the second command.

In another aspect, a method for processing a combined command response based on a markup element is described that includes receiving, via a network from a server node, a first resource including a first combine markup element defined for identifying first combine-request information for a first command identified based on the first resource. The method further includes sending, in response to receiving the first resource, the first combine-request information in a first request message identifying the first command. The method still further includes sending a second request message identifying a second command. The method also includes receiving, in response to sending the first combine-request information, a combined response message including a first command response, in response to the first command, and including a second command response, in response to the second command.

Still further, a system for processing a combined command response based on a markup element is described. The system includes an execution environment including an instruction-processing unit configured to process an instruction included in at least one of a markup content handler component, a request-out component, and a combined response component. The system includes the markup content handler component configured for receiving, via a network from a server node, a first resource including a first combine markup element defined for identifying first combine-request information for a first command identified based on the first resource. The system further includes the request-out component configured for sending, in response to receiving the first resource, the first combine-request information in a first request message identifying the first command. The system still further includes the request-out component configured for sending a second request message identifying a second command. The system also includes the combined response component configured for receiving, in response to sending the first combine-request information, a combined response message including a first command response, in response to the first command, and including a second command response, in response to the second command.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2a is a flow diagram illustrating a method for processing a combined command response based on a markup element according to an aspect of the subject matter described herein;

FIG. 2b is a flow diagram illustrating a method for processing a combined command response based on a markup element according to an aspect of the subject matter described herein;

FIG. 3a is a block diagram illustrating an arrangement of components for processing a combined command response based on a markup element according to another aspect of the subject matter described herein;

FIG. 3b is a block diagram illustrating an arrangement of components for processing a combined command response based on a markup element according to another aspect of the subject matter described herein;

FIG. 4 is a block diagram illustrating an arrangement of components for processing a combined command response based on a markup element according to another aspect of the subject matter described herein;

FIG. 5 is a block diagram illustrating an arrangement of components for processing a combined command response based on a markup element according to another aspect of the subject matter described herein;

FIG. 6 is a network diagram illustrating an exemplary system for processing a combined command response based on a markup element according to an aspect of the subject matter described herein;

FIG. 7 is a diagram illustrating a user interface presented via a display according to an aspect of the subject matter described herein;

FIG. 8 is a message flow diagram illustrating a message flow in a system for processing a combined command response based on a markup element according to an aspect of the subject matter described herein;

FIG. 9a illustrates markup information including an exemplary markup element according to the subject matter described herein;

FIG. 9b illustrates markup information including an exemplary markup element according to the subject matter described herein;

FIG. 9c illustrates markup information including an exemplary markup element according to the subject matter described herein;

FIG. 9d illustrates markup information including an exemplary markup element according to the subject matter described herein;

FIG. 10a illustrates an exemplary request message according to an aspect of the subject matter described herein;

FIG. 10b illustrates an exemplary request message according to an aspect of the subject matter described herein;

FIG. 10c illustrates an exemplary response message according to an aspect of the subject matter described herein;

FIG. 11a Illustrates an exemplary request message according to an aspect of the subject matter described herein; and

FIG. 11b Illustrates an exemplary request message according to an aspect of the subject matter described herein; and

FIG. 11c illustrates an exemplary response message according to an aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art that one or more aspects of the disclosure may be practiced with a lesser degree of these specific details. In other instances, well-known structures and devices are shown in block diagram form in order to facilitate describing one or more aspects of the disclosure.

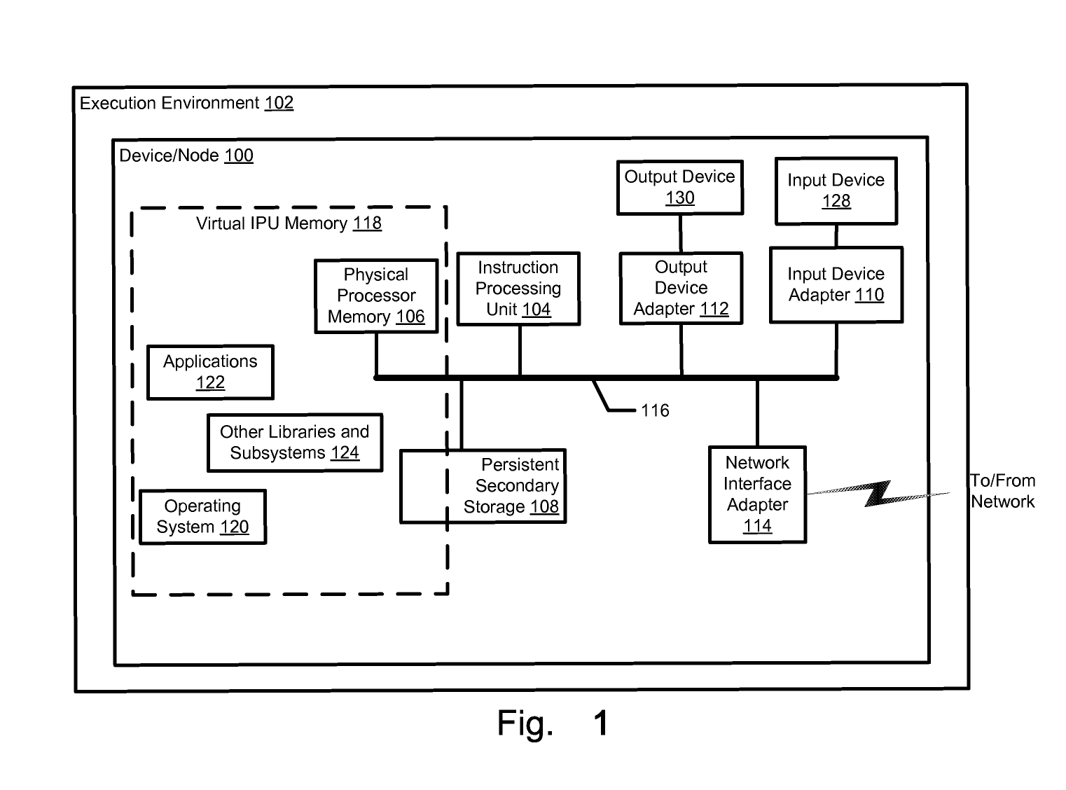

An exemplary device included in an execution environment that may be configured according to the subject matter is illustrated in FIG. 1. An execution environment includes an arrangement of hardware and, optionally, software that may be further configured to include an arrangement of components for performing a method of the subject matter described herein. An execution environment includes and/or is otherwise provided by one or more devices. An execution environment may include a virtual execution environment including software components operating in a host execution environment. Exemplary devices included in or otherwise providing suitable execution environments for configuring according to the subject matter include personal computers, notebook computers, tablet computers, servers, hand-held and other mobile devices, multiprocessor devices, distributed devices, consumer electronic devices, and/or other network-enabled devices. Those skilled in the art will understand that the components illustrated in FIG. 1 are exemplary and may vary by particular execution environment.

FIG. 1 illustrates hardware device 100 included in execution environment 102. FIG. 1 illustrates that execution environment 102 includes instruction-processing unit (IPU) 104, such as one or more microprocessors; physical processor memory 106 including storage locations identified by addresses in a physical memory address space of IPU 104; persistent secondary storage 108, such as one or more hard drives and/or flash storage media; input device adapter 110, such as a key or keypad hardware, a keyboard adapter, and/or a mouse adapter; output device adapter 112, such as a display or audio adapter for presenting information to a user; a network interface component, illustrated by network interface adapter 114, for communicating via a network such as a LAN and/or WAN; and a communication mechanism that couples elements 104-114, illustrated as bus 116. Elements 104-114 may be operatively coupled by various means. Bus 116 may comprise any type of bus architecture, including a memory bus, a peripheral bus, a local bus, and/or a switching fabric.

IPU 104 is an instruction execution machine, apparatus, or device. Exemplary IPUs include one or more microprocessors, digital signal processors (DSPs), graphics processing units, application-specific integrated circuits (ASICs), and/or field programmable gate arrays (FPGAs). In the description of the subject matter herein, the terms “IPU” and “processor” are used interchangeably. IPU 104 may access machine code instructions and data via one or more memory address spaces in addition to the physical memory address space. A memory address space includes addresses identifying locations in a processor memory. The addresses in a memory address space are included in defining a processor memory. IPU 104 may have more than one processor memory. Thus, IPU 104 may have more than one memory address space. IPU 104 may access a location in a processor memory by processing an address identifying the location. The processed address may be in an operand of a machine code instruction and/or may be identified in a register or other portion of IPU 104.

FIG. 1 illustrates virtual processor memory 118 spanning at least part of physical processor memory 106 and at least part of persistent secondary storage 108. Virtual memory addresses in a memory address space may be mapped to physical memory addresses identifying locations in physical processor memory 106. An address space for identifying locations in a virtual processor memory is referred to as a virtual memory address space; its addresses are referred to as virtual memory addresses; and its processor memory is known as a virtual processor memory or virtual memory. The term “processor memory” may refer to physical processor memory 106 and/or virtual processor memory 118 depending on the context in which the term is used.

Physical processor memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), and/or RAMBUS DRAM (RDRAM). Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include removable media. The drives and their associated computer-readable storage media provide volatile and/or nonvolatile storage for computer readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including operating system 120, one or more applications 122, and other program code and/or data components illustrated by other libraries and subsystems 124. In an aspect, some or all software components may be stored in locations accessed by IPU 104 in a shared memory address space shared by the software components. The software components accessed via the shared memory address space are stored in a shared processor memory defined by the shared memory address space. In another aspect, a first software component may be stored in one or more locations accessed by IPU 104 in a first address space and a second software component may be stored in one or more locations accessed by IPU 104 in a second address space. The first software component is stored in a first processor memory defined by the first address space and the second software component is stored in a second processor memory defined by the second address space.

Software components typically include instructions executed by IPU 104 in a context referred to as a “process”. A process may include one or more “threads”. A thread includes a sequence of instructions executed by IPU 104 in a thread context. The terms “thread” and “process” may be used interchangeably herein when a process includes only one thread.

Execution environment 102 may receive user-provided information via one or more input devices illustrated by input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by IPU 104, physical processor memory 106, and/or other components included in execution environment 102.

Output device 130 in FIG. 1 exemplifies one or more output devices that may be included in and/or may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion producing devices, and other output devices producing sensory information detectable by a user.

A device included in or otherwise providing an execution environment may operate in a networked environment communicating with one or more devices via one or more network interface components. The terms “communication interface component” and “network interface component” are used interchangeably. FIG. 1 illustrates network interface adapter (NIA) 114 as a network interface component included in execution environment 102 to operatively couple device 100 to a network. A network interface component includes a network interface hardware (NIH) component and optionally a software component. The terms “network node” and “node” in this document both refer to a device having a network interface component for operatively coupling the device to a network. The terms “device” and “node” as used herein refer to one or more devices and nodes, respectively, providing and/or otherwise included in an execution environment unless clearly indicated otherwise.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The Hypertext Transfer Protocol (HTTP) is specified in “Request for Comments” (RFC) document RFC 2616 by R. Fielding, et al., titled “Hypertext Transfer Protocol—HTTP/1.1” (June 1999). Terms from RFC 2616 are defined below as used herein and are used in describing the subject matter in this document.

The terms “user agent” and “server” refer to roles played by one or more components and/or devices operating in an execution environment, and/or systems in a network communication. A “user agent” initiates and/or sends a command in a request message. A “server” accepts a command identified in a request message in order to process the command. The terms “server”, “service”, and “service provider” are used interchangeably herein. Processing a command includes performing and/or otherwise providing for performing the command. The performing of the command may be successful or unsuccessful. As defined and described herein a server may send information, via a response message, to a user agent in response to receiving a command from the user agent, via a request message.

A “request message” as defined herein is a network message that is initiated, send-able, or sent by a node, including a user agent, for receiving by a node including a server. A node or execution environment including a component operating in a user agent role is referred to herein as a “user agent node”. A node or execution environment including a component operating in a server role is referred to herein as a “server node”. A request message identifies a command for processing by a server operating in a server node. An HTTP request is an exemplary request message. “HTTP request” is defined in section 5 of RFC 2616 along with adaptations and/or extensions described below.

A “response message” is a network message sent as a response to a particular request message sent by a server node to the user agent node that sent the particular “request message”. The response message may include a “command response” as a response to a command identified in the particular request message. An “HTTP response” is an example of a “response message” to a particular HTTP request. “HTTP response” is defined in section 6 of RFC 2616 along with adaptations and/or extensions described below.

A “resource” is a data object or service that can be identified by a universal resource identifier (URI). A “message entity” is information transferred as payload of a network message. An “HTTP entity” is information transferred as payload of an HTTP request or an HTTP response. The term “HTTP entity” as used herein is defined as the term “entity” is defined in RFC 2616. An HTTP entity includes of meta-information in the form of entity-header fields and content in the form of an entity-body. An “HTTP representation” is an HTTP entity that is subject to content negotiation. The term “HTTP representation” is used herein as the term “representation” is used and defined in RFC 2616.

A command identified in a request message may be processed by a service provider. For example, a service provider may retrieve and/or generate a resource in processing a command. As used herein, a “command response” is a result produced in processing a command, from a user agent, identified in a request message. The command response is produced to return to the user agent. A command response is returned in a response message.

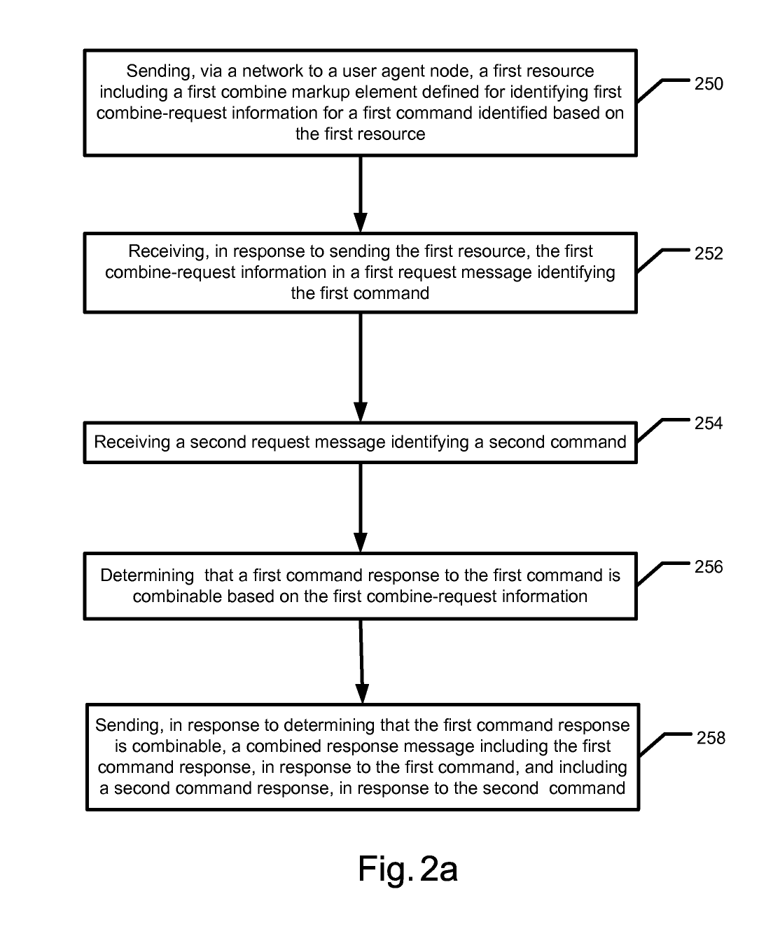

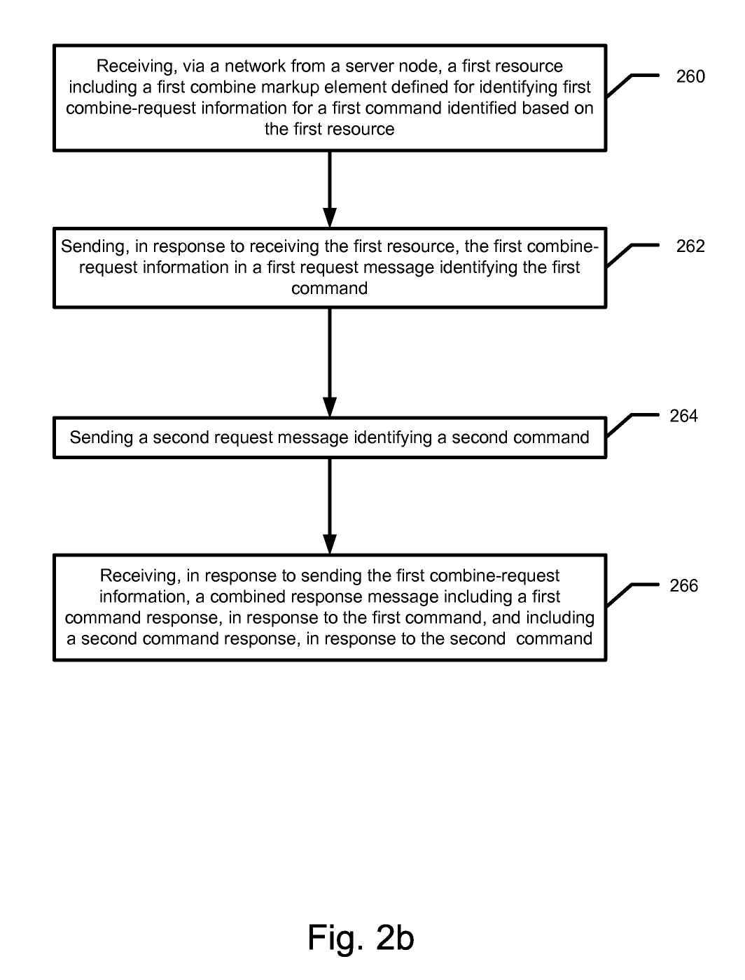

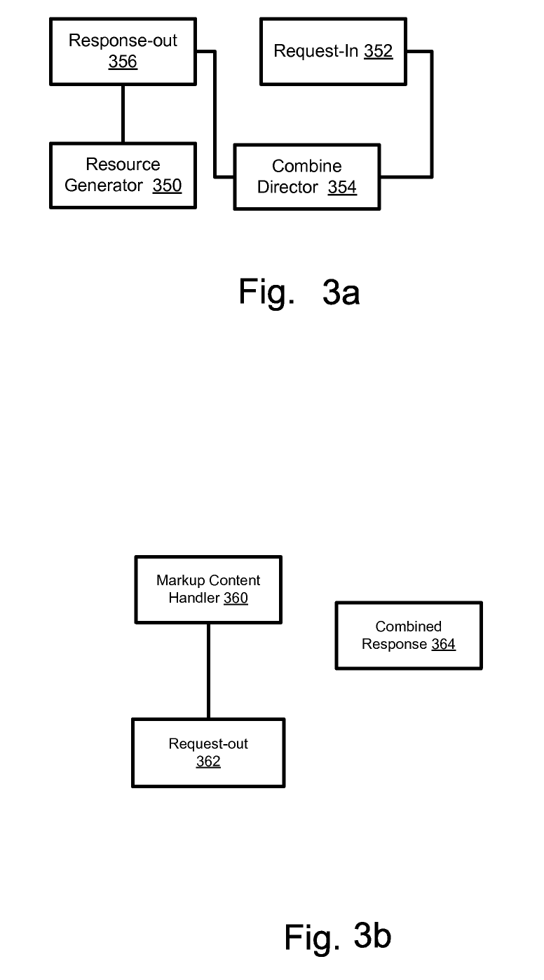

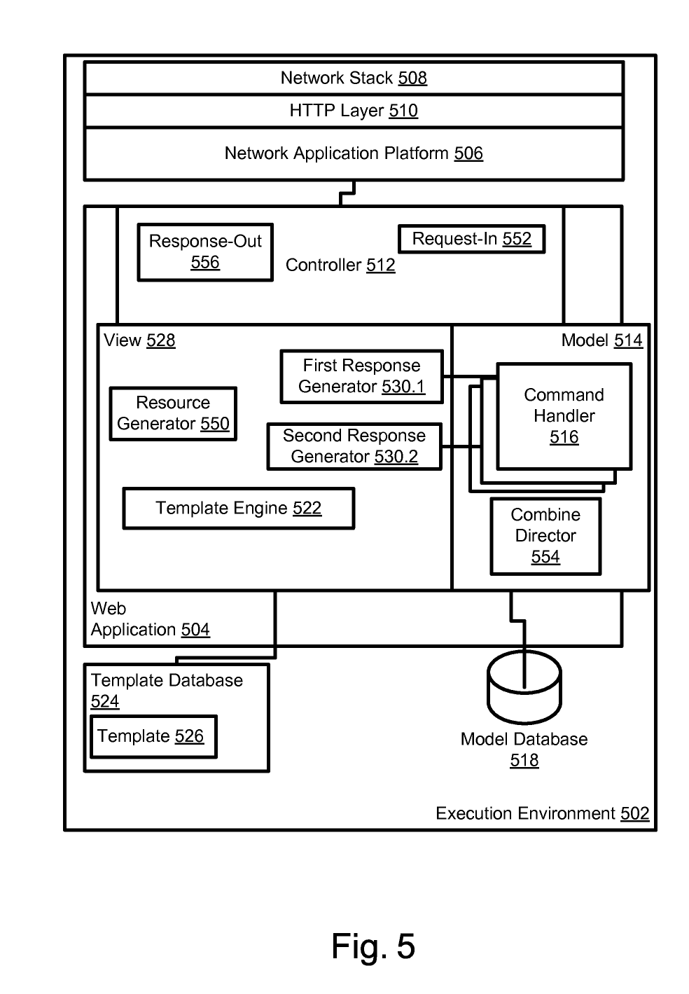

The block diagram in FIG. 3a illustrates an exemplary system for processing a combined command response based on a markup element according to the method illustrated in FIG. 2a. A system for performing the method illustrated in FIG. 2a includes an execution environment, including an instruction-processing unit, configured to process an instruction included in at least one of a resource generator component 350, a request-in component 352, a combine director component 354, and a response-out component 356 illustrated in FIG. 3a. Some or all of the exemplary components illustrated in FIG. 3a may be adapted for performing the method illustrated in FIG. 2a in a number of execution environments. FIG. 5 is a block diagram illustrating the components of FIG. 3a and/or analogs of the components of FIG. 3a adapted for operation in execution environment 502 including or otherwise provided by one or more nodes.

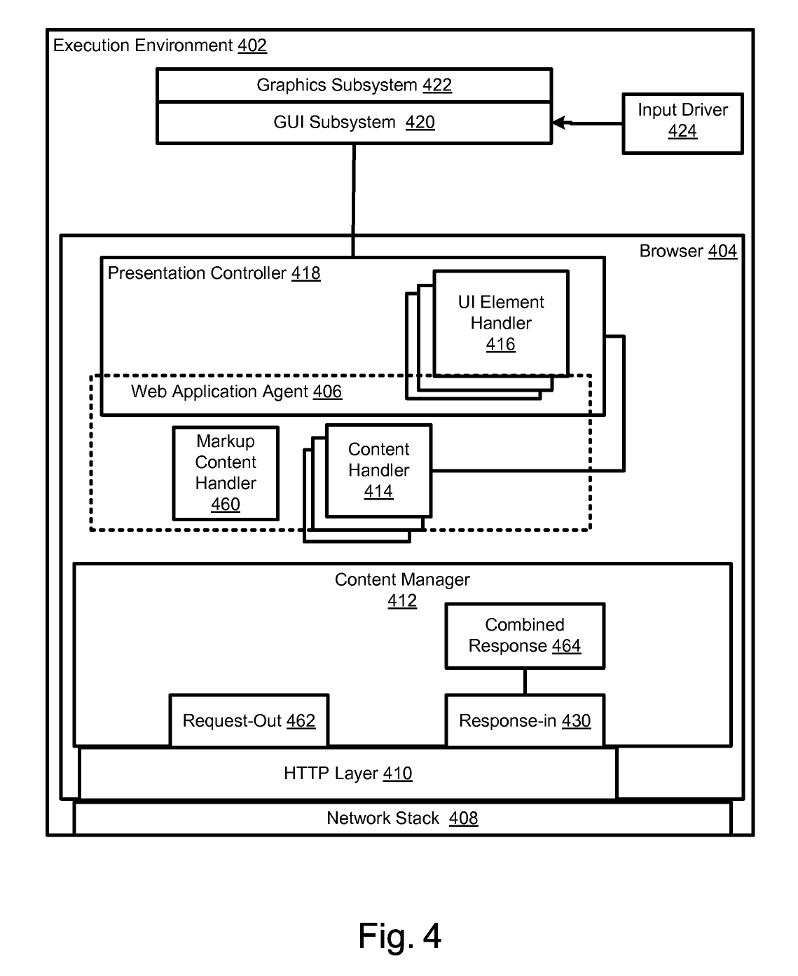

The block diagram in FIG. 3b illustrates an exemplary system for processing a combined command response based on a markup element according the method illustrated in FIG. 2b. A system for performing the method illustrated in FIG. 2b includes an execution environment, including an instruction-processing unit, configured to process an instruction in at least one of a markup content handler component 360, a request-out component 362, and a combined response component 364 illustrated in FIG. 3b. Some or all of the exemplary components illustrated in FIG. 3b may be adapted for performing the method illustrated in FIG. 2b in a number of execution environments. FIG. 4 is a block diagram illustrating the components of FIG. 3b and/or analogs of the components of FIG. 3b adapted for operation in execution environment 402 including or otherwise provided by one or more nodes.

FIG. 1 illustrates components of an exemplary device that may at least partially provide and/or otherwise be included in an execution environment. The components illustrated in FIG. 4 and FIG. 5 may be included in or otherwise combined with the components of FIG. 1 to create a variety of arrangements of components according to the subject matter described herein.

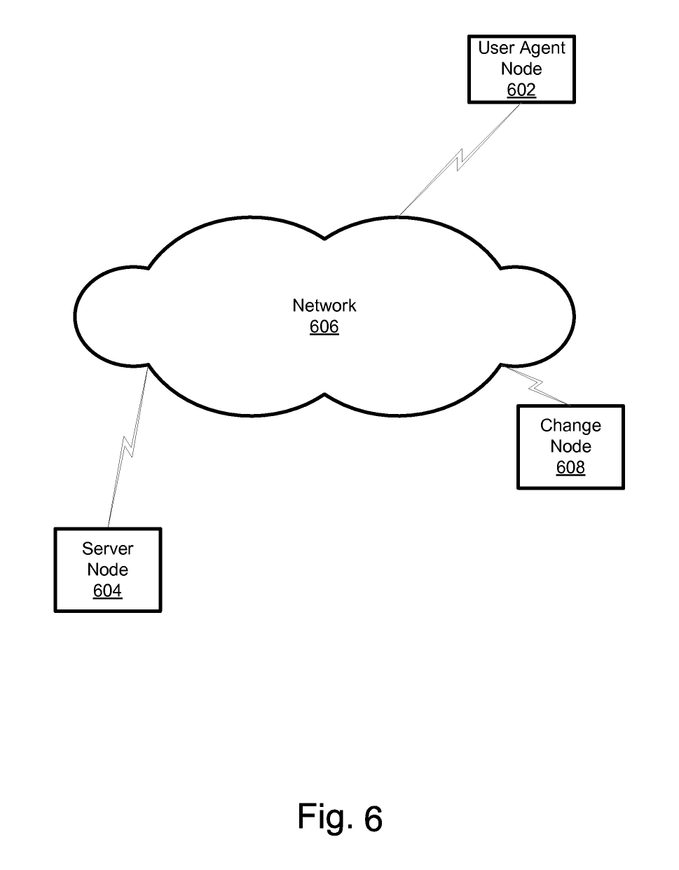

FIG. 6 illustrates user agent node 602 and server node 604 as exemplary devices included in and/or otherwise adapted for providing execution environment 402 and execution environment 502, respectively. As illustrated in FIG. 6, user agent node 602 and server node 604 are operatively coupled to network 606 via respective network interface components enabling user agent node 602 and server node 604 to communicate.

FIG. 4 illustrates execution environment 402 hosting a web browsing application illustrated as browser 404. It is common for a browser and/or a web application agent operating in a browser to operate as user agents. FIG. 4 illustrates browser 404 including an adaptation of the arrangement of components in FIG. 3b. Web application agent 406 is illustrated operating in browser 404 and may be received from a remote application provider, such as web application 504 in FIG. 5. Browser 404 and execution environment 402 may provide at least part of an execution environment for web application agent 406. As defined herein, either or all of browser 404, web application agent 406, HTTP layer 410, and user agent node 602 may operate in the role of user agent and/or include a component operating as a user agent. FIG. 5 illustrates execution environment 502 hosting web application 504, typically operating in the role of a server in a message exchange. FIG. 5 illustrates an adaptation of the arrangement of components in FIG. 3a operating in web application 504.

As stated, the various adaptations of the arrangements in FIG. 3a and in FIG. 3b are not exhaustive. For example, those skilled in the art will see based on the description herein that arrangements of components for performing the methods illustrated in FIG. 2a and FIG. 2b may be distributed across more than one node and/or execution environment. For example, such an arrangement may operate at least partially in browser 404 in FIG. 4 and at least partially in execution environment 502 in FIG. 5.

FIG. 4 illustrates network stack 408 configured for sending and receiving messages over network 606 in FIG. 6, such as the Internet, via a network interface component of user agent node 602. FIG. 5 illustrates a network application platform 506 providing services to one or more web applications. FIG. 5 also illustrates network application platform 506 configured for interoperating with network stack 508. Network stack 408 and network stack 508 may support the same protocol suite, such as TCP/IP, or may communicate via a network gateway or other protocol translation device and/or service. Browser 404 in FIG. 4 and network application platform 506 in FIG. 5 may interoperate via their respective network stacks. Browser 404 and web application 504 may communicate via one or more application layer protocols. FIG. 4 illustrates HTTP layer 410 exemplifying an application layer protocol. FIG. 5 illustrates a compatible HTTP protocol layer as HTTP layer 510.

Browser 404, in FIG. 4, may receive some or all of web application agent 406 as a resource in one more messages sent from web application 504, in FIG. 5, via network application platform 506, network stacks, network interface components, and optionally HTTP layers in the respective execution environments. In FIG. 4, browser 404 includes content manager component 412. Content manager component 412 may interoperate with HTTP layer component 410 and/or network stack 408 to receive the message or messages including some or all of web application agent 406.

Web application agent 406 may include one or more resources, such as a web page or other data representation for presenting a user interface for web application 504. Web application agent 406 may include and/or reference data represented in one or more formats including hypertext markup language (HTML) and/or other markup language, ECMAScript or other scripting language, byte code, image data, audio data, and/or machine code to name just a few valid presentable data representations depending on the capabilities of a receiving user agent node.

In response to a request message identifying a command received from browser 404, controller component 512, in FIG. 5, may invoke model subsystem 514 to perform command specific processing. Model subsystem 514 may include any number of command processors, illustrated as command handler components 516, for dynamically generating data and/or retrieving data from model database 518 based on the command. Controller component 512 may further invoke one or more response generator components 530 included in generating a command response for the received command, which may include a user interface for presenting to a user of browser 404. The one or more response generator components 530 may invoke template engine component 522 to identify one or more templates and/or other static data to combine with data received from command handler component(s) 516 generated in processing the command. FIG. 5 illustrates template database 524 including an exemplary template 526. The one or more response generator component(s) 530 in view subsystem 528 may interoperate with response-out component 556 in controller component 512 to return the command response generated from processing a command in a response message. The command response may be returned in one or more data formats suitable for a user agent, such as browser 404. Response-out component 556 may receive data from one or more response generator components 530 as one or more message entities, such as an HTTP entity that may include an HTTP representation. Alternatively or additionally, response-out component 556 may transform data from one or more response generator component(s) 530 into one or more message entities. Response-out component 556 may send the one or more message entities in a response message, in response to the request message received from browser 404. Some or all of web application agent 406 may be sent to browser 404 via network application platform 506 in the manner described.

One or more response messages including one or more data representations of some or all of web application agent 406 may be received by content manager component 412 via HTTP layer 410 and network stack 408. In FIG. 4, browser 404 includes one or more content handler components 414 to process data received in message entities, such as HTTP representations, according to their data type. A data type may be identified by a MIME type identifier. Exemplary content handler components 414 include a text/html content handler component for processing HTML representations; an application/xmpp-xml content handler component for processing XMPP streams including presence tuples, instant messages, and publish-subscribe data as defined by various XMPP specifications; one or more video content handler components for processing video representations of various types; and still image data content handler components for processing various image data representations. Content handler component(s) 414 process received HTTP representations and may provide data from the HTTP representations to one or more user interface element handler components 416.

User interface element handler components 416 are illustrated in presentation controller component 418 in FIG. 4. Presentation controller component 418 may manage visual, audio, and other types of output for its including application as well as receive and route detected user and other inputs to components and extensions of its including application, browser 404. With respect to FIG. 4, a user interface element handler component 416 may be adapted to operate at least partially in a content handler component 414 such as a text/html content handler component and/or a script content handler component. Additionally or alternatively, a user interface element handler component in execution environment 402 may operate in web application agent 406 and/or other extension of its including application, such as a plug-in component providing a virtual machine for script and/or byte code.

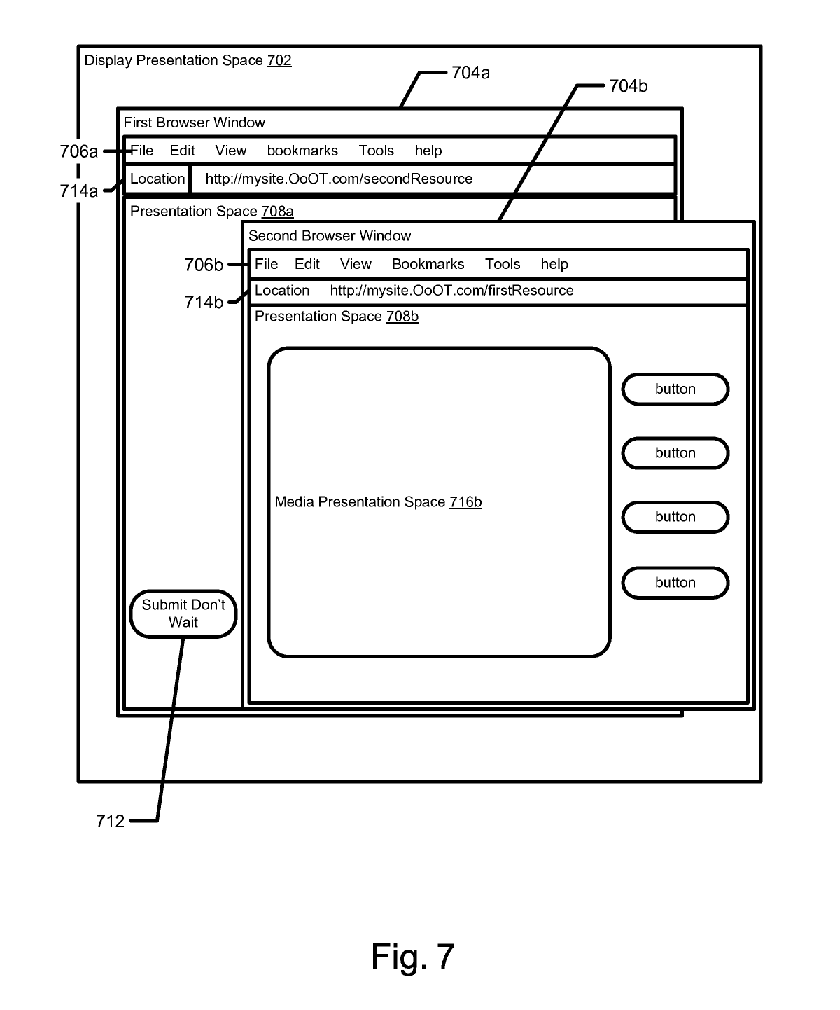

FIG. 7 illustrates a presentation space 702 of a display device, such as output device 130 in FIG. 1, including first browser window 704a of browser 404, web application agent 406, and/or web application 504. FIG. 7 is used to illustrate various exemplary visual components of one or more of browser 404, web application agent 406, and web application 504.

The components of a user interface are generically referred to herein as user interface elements. More specifically, visual components of a user interface are referred to herein as visual interface elements. A visual interface element may be a visual component of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the exemplary elements listed. Those skilled in the art will understand that this list is not exhaustive. The terms “visual representation”, “visual component”, and “visual interface element” are used interchangeably in this document. Other types of user interface elements include audio output components referred to as audio interface elements, tactile output components referred to as tactile interface elements, and the like.

A “user interface (UI) element handler” component, as the term is used in this document, includes a component configured to send information representing a program entity for presenting a user detectable representation of the program entity by an output device, such as a display. A “program entity” is an object included in and/or otherwise processed by an application or executable program component. The user detectable representation is presented based on the sent information. The sent information is referred to herein as “presentation information”. Presentation information may include data in one or more formats including image formats such as JPEG, video formats such as MP4, markup language data such as HTML and other markup based languages, and/or instructions such as those defined by various script languages, byte code, and/or machine code. For example, a web page received by a browser from a remote application provider may include HTML, ECMAScript, and/or byte code for presenting one or more user interface elements included in a user interface of the remote application. Components configured to send information representing one or more program entities for presenting particular types of output by particular types of output devices include visual interface elements, audio interface element handler components, tactile interface element handler components, and the like.

A representation of a program entity may be represented and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space. A presentation space may be physically and/or logically contiguous or non-contiguous. A presentation space may have a virtual as well as a physical representation. A presentation space may include a storage location in processor memory, secondary storage, a memory of an output device adapter device, and/or a storage medium of an output device. A screen of a display, for example, is a presentation space.

As used herein, the terms “program”, “program component”, “application”, “application component”, “executable” and “executable component” refer to any data representation that may be translated into a set of machine code instructions and optional associated program data. Thus, a program or executable may include an application, a shared or non-shared library, and a system command. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear that state of the object code when it is relevant. This definition includes machine code and virtual machine code, such as Java™ byte code.

Returning to FIG. 7, first browser window 704a and second browser window 704b collectively and generically are referred to as browser window(s) 704. Browser windows 704 illustrate a number of visual user interface elements commonly found in applications. Browser windows 704 include respective menu bars 706 with menu controls for receiving user input to identify commands to perform. Browser windows 704 also include respective user interface elements providing respective presentation spaces 708 for presenting content including other visual components.

Various user interface elements of browser 404, web application agent 406, and/or web application 504 described above may be presented by one or more user interface element handler components 416 and/or response generator components 530. User interface element handler component(s) 416 in FIG. 4 may send presentation information representing a visual interface element(s), such as menu bar 706 illustrated in FIG. 7, to GUI subsystem 420. GUI subsystem 420 may instruct graphics subsystem 422 to draw the visual interface element(s) in a region of display presentation space 702 in FIG. 7, based on the presentation information.

Input may be received via input driver 424 in FIG. 4. For example, a user may move a mouse to move a pointer presented in display presentation space 702 over an operation identifier in menu bar 706. The user may provide an input detected by the mouse. The detected input may be received by GUI subsystem 420 via input driver 424 as an operation or command indicator based on the association of the shared location of the pointer and the operation identifier in display presentation space 702.

A “combinable command” is a command having a command response that may be sent to a user agent that sent the command in a response message with another command response of another combinable command. The command response of a combinable command is referred to herein as a “combinable command response”. A response message that includes multiple combinable command responses is referred herein as a “combined response message”. When included in a combined response message, a command response is referred to herein as “combined command response”. A combined response message may include a status code for the combined response message referred to herein as a “combined status code”. A combined response message may include zero or more command specific status codes associated with particular combined command responses included in the combined response message.

Note that a combined response message differs from an attached response message as defined and described in application Ser. No. 12/788,364 (Docket No 0103) filed on 2010 May 27, entitled “Methods, Systems, and Program Products for Processing an Attached Command Response”. An attached response message is a response message for a particular request message that includes a command response for a command identified in another request message. The other request message may have its own specific command response that when sent includes at most a portion of the command response for the other command identified in the other request message.

With reference to FIG. 2a, block 250 illustrates that the method includes sending, via a network to a user agent node, a first resource including a first combine markup element defined for identifying first combine-request information for a first command identified based on the first resource. Accordingly, a system for processing a combined command response based on a markup element includes means for sending, via a network to a user agent node, a first resource including a first combine markup element defined for identifying first combine-request information for a first command identified based on the first resource. For example, as illustrated in FIG. 3a, resource generator component 350 is configured for sending, via a network to a user agent node, a first resource including a first combine markup element defined for identifying first combine-request information for a first command identified based on the first resource. FIG. 5 illustrates resource generator component 550 as an adaptation of and/or analog of resource generator component 350 in FIG. 3a. One or more resource generator components 550 operate in execution environment 502.

With reference to FIG. 2b, block 260 illustrates that the method includes receiving, via a network from a server node, a first resource including a first combine markup element defined for identifying first combine-request information for a first command identified based on the first resource. Accordingly, a system for processing a combined command response based on a markup element includes means for receiving, via a network from a server node, a first resource including a first combine markup element defined for identifying first combine-request information for a first command identified based on the first resource. For example, as illustrated in FIG. 3b, the markup content handler component 360 is configured for receiving, via a network from a server node, a first resource including a first combine markup element defined for identifying first combine-request information for a first command identified based on the first resource. FIG. 4 illustrates markup content handler component 460 as an adaptation of and/or analog of markup content handler component 360 in FIG. 3b. One or more markup content handler components 460 operate in execution environment 402.

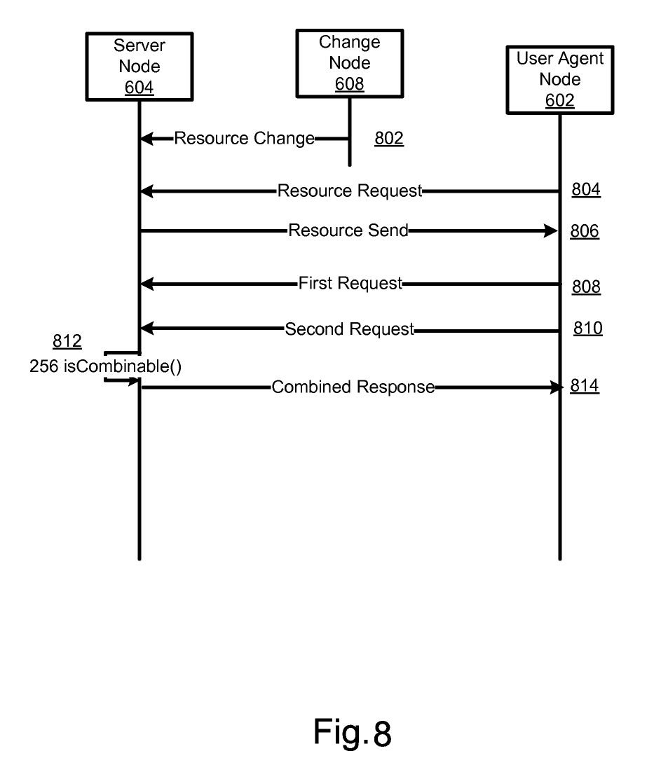

A resource may be sent via a network in a message as illustrated by resource send message 806 in FIG. 8. Resource send message 806 may be sent in response to a change in the resource detected by server node 604 and/or in response to a request to access the resource. The resource may be sent in response to receiving a message via a network for changing and/or otherwise accessing the resource. Resource send message 806 is transmitted via network 606 according to a specified protocol. The protocol specified may include a request/response protocol, a publish-subscribe protocol, and/or an asynchronous protocol specifying a message transmitted asynchronously without a corresponding request or subscription.

When a resource is sent according to a request/response protocol specification, a request message for the resource may be sent by a user agent node and received by a server node. In accordance with the protocol, the resource may be sent by the server node in a response message to the request message for receiving by the user agent node. FIG. 8 illustrates user agent node 602 sending a resource request message 804 according to a request/response protocol for receiving by server node 604. In an aspect, HTTP may be the request/response protocol. Resource request message 804 may include an HTTP request including a URI identifying the resource and including an HTTP method token. The method token and the URI may be included in command information identifying a command for accessing the resource by the server and returning a representation of the resource in a command response in the response message. Resource send message 806 in FIG. 8 illustrates the response message in a request/response communication.

In another aspect, a resource may be sent in a notification message in response to receiving a change message including change information for creating and/or otherwise changing the resource. In FIG. 8, resource change message 802 may be a publish message including change information for updating the resource according to a publish-subscribe protocol. Resource change message 802 may be sent by change node 608 in FIG. 8 to server node 604. In response, to receiving the change information server node 604 may send resource send message 806 as a notification message to user agent node 602 according to the publish-subscribe protocol. User agent node 602 may receive resource send message 806 based on a subscription to the resource or may receive the resource send message 806 as a directed-notify message without having a subscription for resource notification messages. A directed-notify message is an asynchronous message.

In still another aspect, a resource may be sent in response to an event other than receiving a message via a network. A server node may receive and/or otherwise detect change information indicating a change to a resource. In response to the change information, the resource may be sent asynchronously according to an asynchronous protocol. For example, server node 604 may detect a change to a resource via a system administrator through a user interface provided by server node 604. Change information may be received via the user interface indicating a change to the resource. Server node 604 may send the resource asynchronously in resource send message 806 in FIG. 8, for example as an event message received by user agent node 602.

As indicated above, server node 604 in FIG. 6 may include and/or may otherwise be included in execution environment 504 in FIG. 5. Request-in component 552 may receive a command sent in resource request message 804 in FIG. 8 for accessing the resource. Resource request message 804 may be sent by request-out component 462 in FIG. 4 in browser 404 operating in user agent node 602. For example, request-out component 462 may be invoked in response to presentation controller component 418 detecting a selection of a hyperlink for accessing the resource presented in a web page. Request-in component 552 and controller component 512 may invoke a command handler component 516 to process the command. The command handler component 516 may interoperate with resource generator component 550 to transform the result produced by the command handler component 516 into a representation of the resource that is suitable for browser 404 in user agent node 602 that sent resource request message 804. Resource generator component 550 may be a particular response generator component 530 associated with the requested resource. Resource generator component 550 may interoperate with response-out component 556 to send resource send message 806 as a response to resource request message 804. Response-in component 430 may receive the resource sent in resource send message 806 and process the resource as described above. For example, the resource may include and/or may be included in web application client 406.

Web application 504, additionally, may be configured to receive resource change message 802 via a publish-in component (not shown) for receiving change messages according to a particular publish-subscribe protocol. A notification-out component (not shown) and subscription handler component (not shown) may be included in web application 504 for sending notification messages and processing subscription messages, respectively.

Web application 504 may be configured to receive any of the various adaptations and/or analogs of resource change message 802 and/or resource request message 804 described. Web application 504 may be configured to send any of the adaptations and/or analogs of resource send message 806 described above. Analogously, browser 404 operating in execution environment 402 including and/or included in user agent node 602 may be configured to send any of the adaptations and/or analogs of resource request message 804 and to receive resource send message 806 in any of its adaptations and/or analogs described.

A first resource and/or a combine markup element may include representation information for presenting a user detectable representation via an output device of user agent node 602 by browser 404. For example, the resource may include a web page including HTML markup elements and/or other markup, one or more script instructions, and/or one or more media representations such as an image, a video, and/or or audio data. One or more of the user interface elements presented in presentation space 708b in FIG. 7, for example, may be representations of markup elements included in and/or including a combine markup element, such as submit-don't-wait UI element 712a in presentation space 708a of first browser window 704a in FIG. 7. A markup element for submit-don't-wait UI element 712a may identify a command to perform in response to an event detected corresponding to submit-don't-wait UI element 712a.

Returning to FIG. 2b, block 262 illustrates that the method further includes sending, in response to receiving the first resource, the first combine-request information in a first request message identifying the first command. Accordingly, a system for processing a combined command response based on a markup element includes means for sending, in response to receiving the first resource, the first combine-request information in a first request message identifying the first command. For example, as illustrated in FIG. 3b, the request-out component 362 is configured for sending, in response to receiving the first resource, the first combine-request information in a first request message identifying the first command.

FIG. 8 illustrates user agent node 602 in the role of a user agent sending a first command identified in first request message 808 received by server node 604. First request message 808 includes first command information identifying the first command for processing by server node 604. The first command has a combinable command response as defined above and described below. FIG. 8 illustrates user agent node 602 sending a second command in second request message 810. FIG. 8 illustrates second request message 810 sent after first request message 808. In various aspects, the second command may be sent by browser 404 to web application 504 in second request message 810 before, during, or after the first command in the first request message 808 is sent.

Adaptations and/or analogs of request-out component 362 in FIG. 3b, such as request-out 462 in FIG. 4 may send a request message in various contexts. For example, browser 404 may send a request message in response to a user input, in response to processing a reference included in a web page and/or other resource, and/or in response to execution of an instruction in a script, by a plug-in component and/or other extension of browser 404.

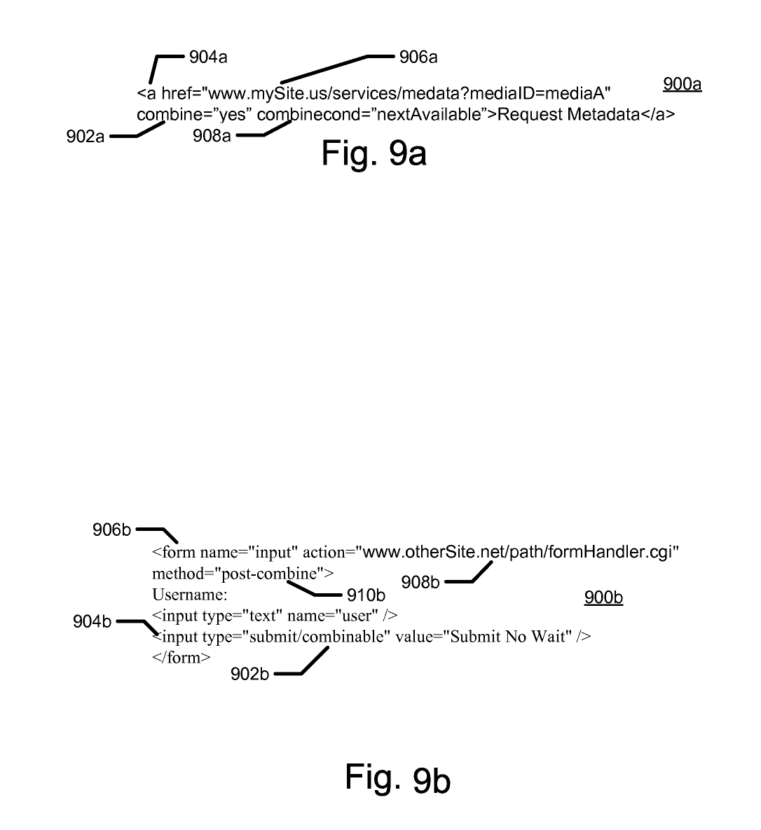

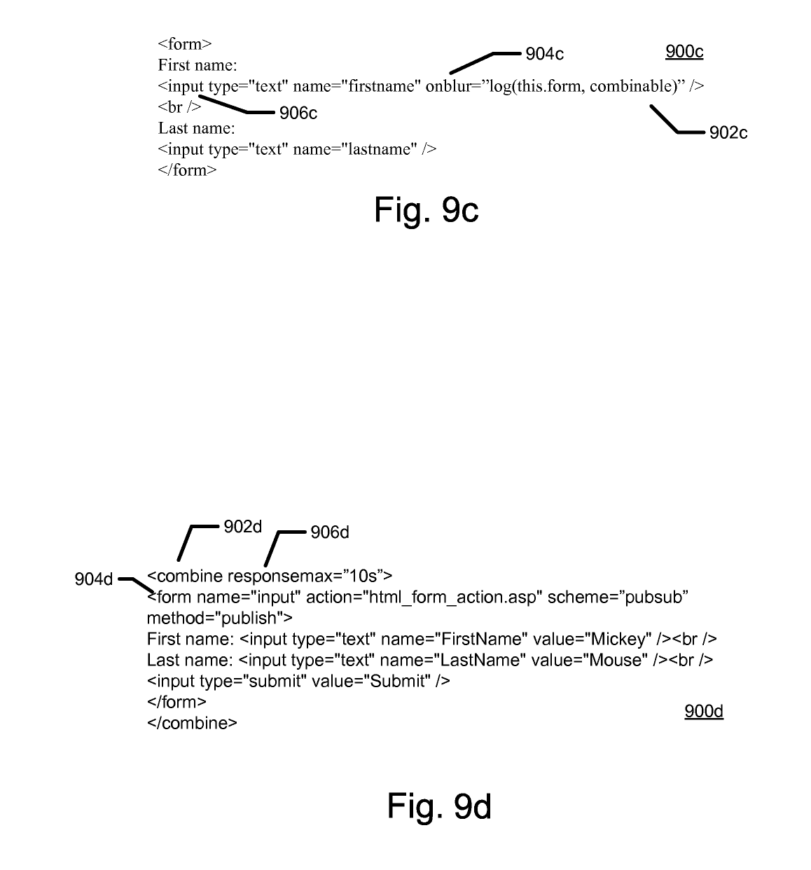

FIG. 9a, FIG. 9b, FIG. 9c, and FIG. 9d illustrate various resources and/or portions of resources including a combine markup element according to various aspects of the subject matter described herein. The figures illustrate that in various aspects a combine markup element may include and/or be included in markup elements such as a hyperlink markup element, a form markup element, and/or an event markup element to name a few examples.

FIG. 9a illustrates markup 900a including combine markup element 902a as a combine attribute in a hyperlink markup element 904a illustrate as a hypertext markup language (HTML) anchor tag “<a/>”. FIG. 9b illustrates markup 900b including combine markup element 902b as a value of an attribute in <input> tag 904b in an HTML <form> tag 906b. Combine markup element 902b is illustrated in FIG. 9b the value “submit/combinable” assigned to a type attribute. “combinable”, may identify a subtype of the submit input type. In FIG. 7, submit-don't-wait UI element 712a may be a visual representation based on input tag 904b. FIG. 9c illustrates markup 900c including combine markup element 902c as a parameter for a script routine assigned to “onblur” event attribute 904c in an HTML <input> tag 906c. FIG. 9d illustrates markup 900d including combine markup element 902d illustrated as a <combine> tab. Combine markup element 902d is a parent markup tag including a form tag 904d, which includes a number of descendent markup elements defined by the nested structure of the markup language. As a parent tag, combine markup element 902d may be defined to indicate that commands identified by descendent markup elements have combinable command responses and/or to indicate that request messages generated based on the identified commands have combinable command responses according to various aspects. The combine markup elements illustrated in FIG. 9a, FIG. 9b, FIG. 9c, and FIG. 9c may be processed to generate combine-request information for including in respective request messages including command information based on the respective markup information in FIG. 9a, FIG. 9b, FIG. 9c, and FIG. 9d.

While FIG. 9a, FIG. 9b, FIG. 9c, and FIG. 9d illustrate combine markup elements included in HTML markup information, combine markup elements may be defined according to other markup languages including SOAP, resource description framework (RDF), Apache ANT, standard general markup language (SGML), and various other markup languages.

Any of the exemplary markup information illustrated in FIG. 9a, FIG. 9b, FIG. 9c, and FIG. 9d may processed by a compatible content handler component 414, such as markup content handler 460. The content handler component 414 may interoperate with one or more UI element handler components 416 to present a user detectable representation of the markup information to a user via an output device. For example, the received resource may include markup 900a in FIG. 9a to present a selectable link in presentation space 708a of first browser window 704a or to present some other a selectable input control, such as submit-don't-wait UI element 712. FIG. 4 illustrates that a user input may be received by presentation controller component 418 and/or a UI element handler component 416 corresponding to the link or to submit-don't-wait UI element 712 in the resource received in resource send message 806 including the first combine markup element. The hyperlink markup element 904a in FIG. 9a identifies a command associated with the presented link. <input> tag 904b in FIG. 9b identifies a command associated with a form submit UI element, which may be submit-don't-wait UI element 712 in FIG. 7.

In response to a user input for selecting the link presented in presentation space 708a in FIG. 7 or in response to detecting some other configured event, event information may be received by presentation controller component 418 and/or a UI element handler component 416. In an aspect, presentation controller component 418 and/or the UI element handler component 416 may interoperate with a markup content handler component 460 to match the event with command information stored in a document object model (DOM) maintained by markup content handler component 460 and generated based on the markup information included in the received resource.

Markup content handler component 460 may interoperate with content manager component 412 to generate command information to send in a request message to web application 504 in FIG. 5 operating in server node 604 in FIG. 6 identified by the URI in the hyperlink markup element 904a in FIG. 9a. The request message may be sent as describe above. For example, the request message may be sent as an HTTP request. First request message 808 and second request message 810 may be sent in this manner and/or in an analogous manner according to another suitable protocol. One of first request message 808 and second request message 810 may be sent in response to a user selection of a bookmark, a history item, and/or other event identifying server node 604 and a command.

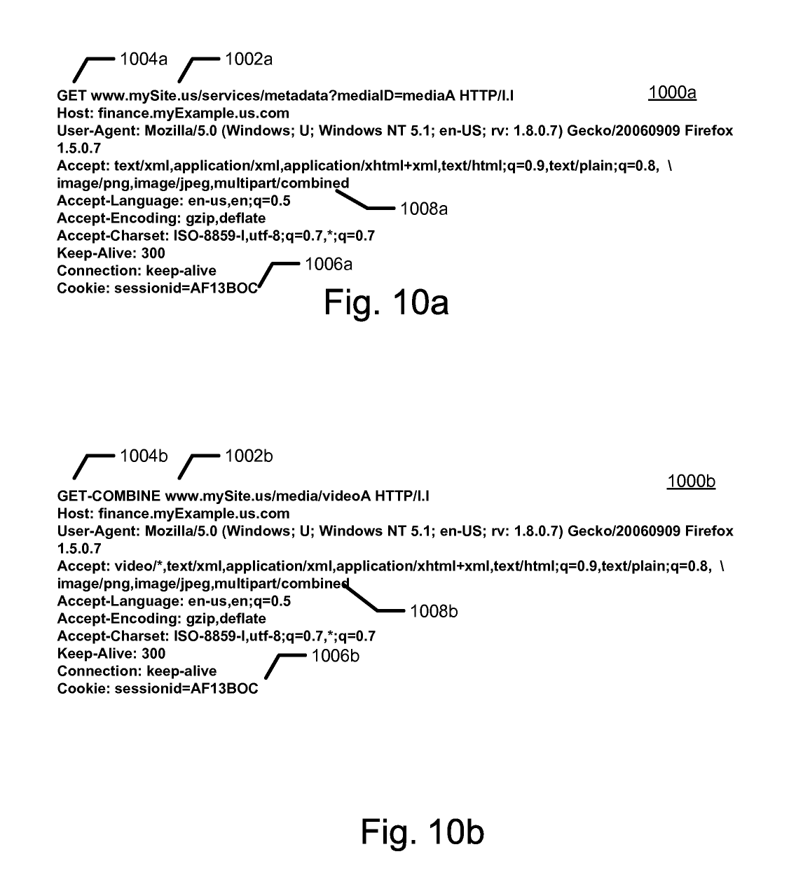

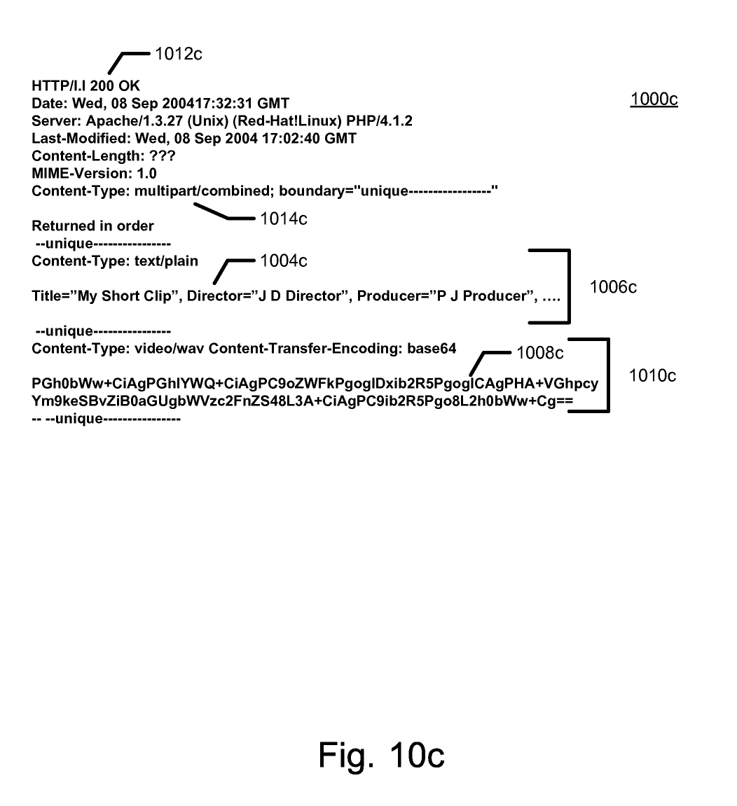

FIG. 10a, FIG. 10b, and FIG. 10c illustrate various exemplary request messages and response messages as HTTP messages included in an HTTP communication between browser 404 operating in user agent node 602 and web application 504 operating in server node 604. FIG. 10a illustrates first HTTP request 1000a including first command information identifying a first command. The first command information in HTTP request 1000a includes first URI 1002a based on href attribute value 906a in FIG. 9a illustrated as “www.mySite.us/services/medata?mediaID=mediaA” identifying a metadata service for retrieving metadata for an identified media item. The media item is identified, in FIG. 10a, in first URI 1002a by query parameter “mediaID” having a value of “mediaA”. First command information in HTTP request 1000a may also include HTTP method token 1004a illustrated as “GET”. The first command information may include information in an HTTP header. For example, cookie header 1006a identifies a session identifier illustrated by a “sessionid” cookie. A server may identify a command or an aspect of a command based on a value of a cookie and/or other HTTP header information. Server node 604 may be identified by a host portion of first URI 1002a, “www.mySite.us”. Command information identifying the first command in first HTTP request 1000a may include information in one or more of first URI 1002a, HTTP method token 1004a, and cookie header 1006a.

First HTTP request may include first combine-request information illustrated by multipart/combined MIME type 1008a. An HTML content handler component 414 and/or content manager component 412 may include MIME type 1008a in first HTTP request 1000a based on combine markup element 902a in FIG. 9a.

First command 1000a may be generated by browser 404 in response to receiving the resource from server node 604. The resource may include markup 900a including combine markup element 902a. Markup 900a may be received by browser 404 in the resource received in resource send message 806 in FIG. 8 or may be received in a second resource received in a second resource send message (not shown).

First HTTP request 1000a may be sent by request-out component 462 as instructed by content manager component 412 to HTTP layer 410. HTTP layer 410 may sent the request message illustrated by first request message 808 in FIG. 8 to server node 604.

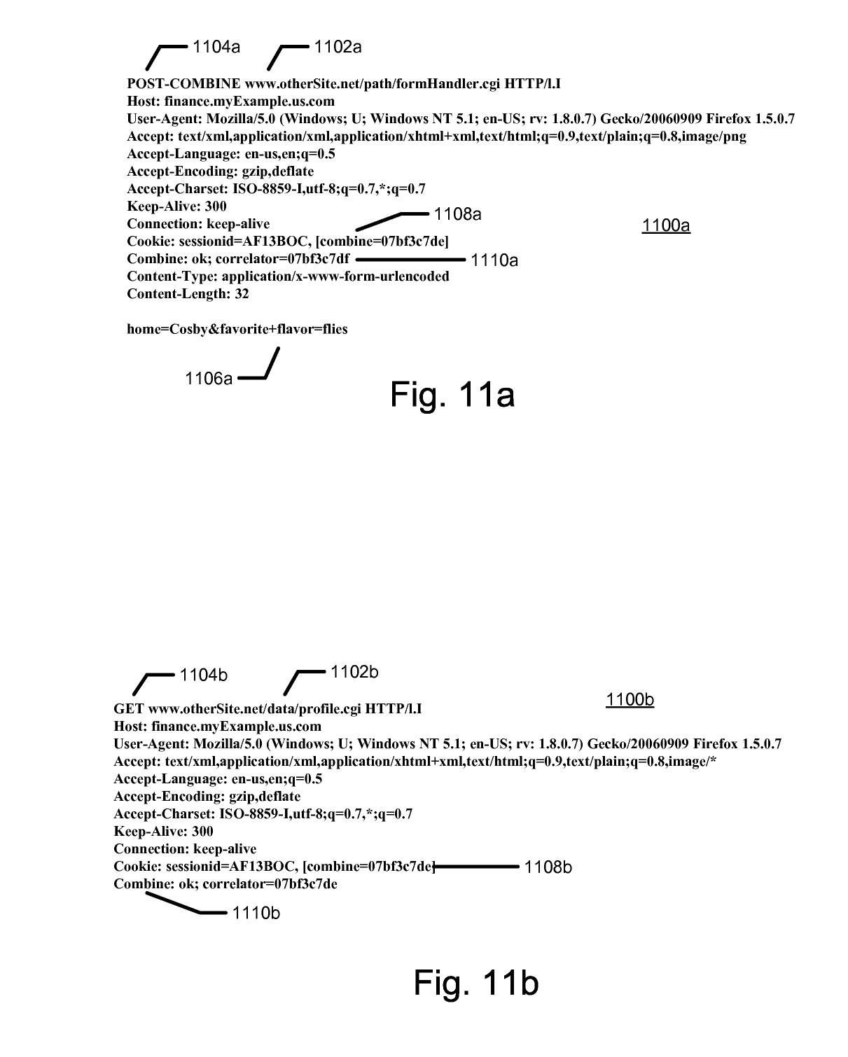

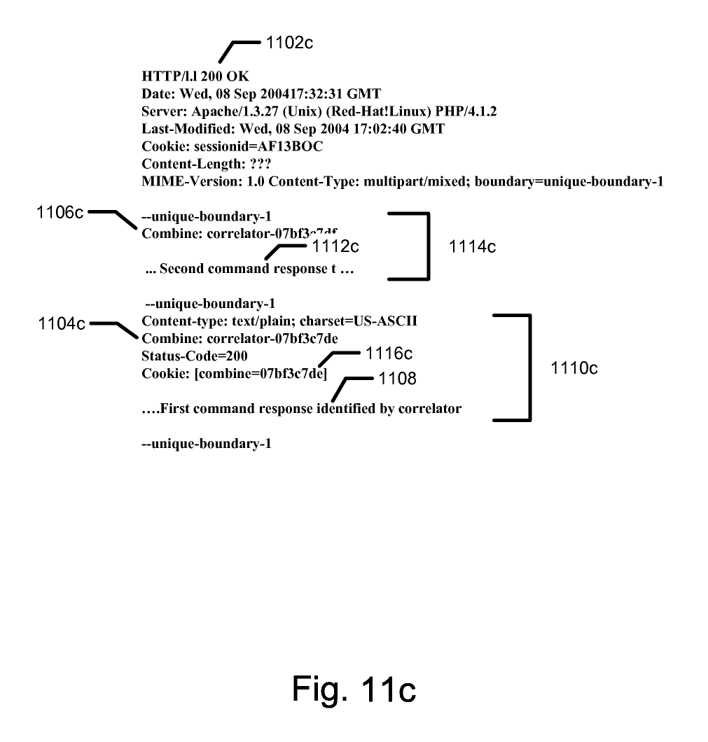

FIG. 11a, FIG. 11b, and FIG. 11c also illustrate various exemplary HTTP messages included in an HTTP communication between browser 404 operating in user agent node 602 and web application 504 operating in server node 604. FIG. 11a illustrates first HTTP request 1100a. First HTTP request 1100a includes first URI 1102a illustrated as www.otherSite.net/path/formHandler component.cgi identifying a service for processing a form. First HTTP request 1100a also includes HTTP method token 1104a illustrated as “POST-COMBINE”. First command information may include form input 1106a. Form input 1106a is illustrated as an HTTP representation encoded according to MIME type “application/x-www-form-urlencoded”. Server node 604 may be identified by a host portion of first URI 1102a, www.otherSite.net. Command information identifying the first command in first HTTP request 1100a may include information in one or more of first URI 1102a, HTTP method token 1104a, and an HTTP entity that may be and/or may include an HTTP representation 1106a.

First HTTP request 1100a may be generated by browser 404 in response to receiving a resource from server node 604. The resource may include markup 900b including combine markup element 902b illustrated as a string, “combinable” in a value of an “onblur” event attribute in <input> tag 904b. Whenever a representation of the input element presented on a display device loses input focus, a script routine “log( )” routine is invoked with the “combinable” value passed as a parameter. Markup information 900b may be received by browser 404 in the resource received in resource send message 806 in FIG. 8 or may be received in a second resource received in a second resource send message (not shown).

In processing, an onblur event, browser 404 may generate first HTTP request 1100a, for example, to send in first request message 808 in FIG. 8 to server node 604. In addition to including the command information described above, first HTTP request 1100a may include combine-request information illustrated in FIG. 11a by combine header 1110a. Combine header 1110a may be defined with one of several valid values for determining whether first HTTP request 1100a identifies a command with a combinable command response. Combine header 1110a may be included in first HTTP request 1100a based on combine markup element 902b in FIG. 9b.

Command information as well as combine-request information, if any, may be provided to and/or generated by content manager component 412 to generate a request message including the command information, to identify a command for performing by a server. Command information may further include a method token, such as an HTTP method token in an HTTP request. An HTTP method token may be provided by browser 404 and/or web application agent 406. Content manager component 412 in FIG. 4, operating in user agent node 602, may interoperate with HTTP layer 410 to send the first command information in first request message 808 to server node 604 via network 606. Server node 604 may be identified and located in network 606 by the first URI. First request message 808 may include first HTTP request 1000a or first HTTP request 1100a including combine-request information based on combine markup element 902a in FIG. 9a and combine markup element 902b in FIG. 9b.

A second request message illustrated by second request message 810 in FIG. 8 may be sent in an analogous manner. Second HTTP request 1000b in FIG. 10b illustrates an exemplary HTTP request that may be sent in and/or as second request message 810. Second HTTP request message 1000b includes command information identifying a command for processing by web application 504 in server node 604. The command information may include and/or otherwise may be based on URI 1002b, HTTP method token 1004b, and/or one or more headers such as Cookie header 1006b. Second HTTP request 1000b may include second combine-request information based on a combine markup element included in a resource for generating second HTTP request 1000b. Combine-request information in second HTTP request 1000b may include “GET-COMBINE” HTTP method token 1004b and/or multipart/combined MIME type identifier 1008b.

During processing of a first combinable command and/or a second combinable command by a server, a user agent that sent the combinable commands, to the server, may send, in a third request message, third command information identifying a third command. The server may receive third command information identifying the third command while processing the first command and/or the second command. The server node may send a third response message in response to the third request message including a third command response to the third command. The user agent may receive the third response message. The third command response may be at least partially generated during processing of at least one of the first command and the second command by the server.

The third request message described in the previous paragraph may include do-not-combine-request information to instruct the server to send the third command response in the third response message. In an aspect, do-not-combine-request information may be detected as lack of combine-request information indicating that the third command is combinable.

Returning to FIG. 2a, block 252 illustrates that the method yet further includes receiving, in response to sending the first resource, the first combine-request information in a first request message identifying the first command. Accordingly, a system for processing a combined command response based on a markup element includes means for receiving, in response to sending the first resource, the first combine-request information in a first request message identifying the first command. For example, as illustrated in FIG. 3a, request-in component 352 is configured for receiving, in response to sending the first resource, the first combine-request information in a first request message identifying the first command. FIG. 5 illustrates request-in component 552 as an adaptation of and/or analog of request-in component 352 in FIG. 3a. One or more request-in components 552 operate in execution environment 502.

Request-in component 552 in FIG. 5, may receive a request message such as first request message 808 in FIG. 8 and/or second request message 810 from user agent node 602 via network stack 508, HTTP layer 510, and network application platform 506 as described above. Request-in component 552 may receive some or all information in a request message by interoperating with network application platform 506. Request-in component 552 may identify a command received in a request message, such as the first command in first request message 808 and/or the second command in second request message 810. Request-in component 552 may interoperate with one or more components in controller component 512 to identify a command handler component 516 to perform an operation included in processing the command.

A first command handler component 516 may be invoked in response to the first command information included in first request message 808 and a second command handler component 516 may be invoked in response to the second command information in second request message 810. Controller component 512 and/or request-in component 552 may identify a command handler component 516 based on some or all of a URI included in command information. Command information identifying a command may be processed by controller component 512 in identifying a suitable command handler component 516. One or more components of model subsystem 514 may be included in providing information to one or more command handler components 516 to perform an operation included in processing the command.

A command, such as the first command identified in first request message 808 in FIG. 8 and the second command identified in second request message 810, may be identified by command information included in a request message based on a combine markup element and/or a markup element including and/or included in a combine markup element. FIG. 9a, FIG. 9b, FIG. 9c, and FIG. 9d illustrate that a command may be identified by at least one of a hyperlink markup element, a form markup element, and an event markup element. In FIG. 9a, an “href” attribute value 906a may be included in command information identifying a command in a request message. In, FIG. 9b, action attribute value 908b, method value 910b, and data included in one or more input tags may be included in command information and/or otherwise included in generating command information.

A form markup element may be specified for receiving user input. User data may be received that corresponds to a user detectable representation of the form element presented via an output device of the user agent node. Command information may include user data and/or may otherwise be based on the form markup element. FIG. 9b, FIG. 9c, and FIG. 9c all illustrate form markup elements that affect the content of corresponding command information based on user data received for the respective forms.

An event markup element may identify an event to be detected by the user agent node for sending a request message for receiving by a server node that sent the event markup language in a resource including a combine markup element. The event may be based on and/or may be detected based on a user input, a specified time, a specified duration of time, a specified condition when met, and on execution of an instruction sent from the server node to the user agent node. Hyperlink markup element 904a in FIG. 9a identifies a selection input event for sending a request message. <form> tag 906b in FIG. 9b and <form> tag 904d in FIG. 9d identify respective events for submitting form information. <input> tag 906c in FIG. 9c identifies “onblur” event. FIG. 9d illustrates responsemax attribute 908d specifying a duration of time for determining whether a command has a combinable command response.

As illustrated by combine tag 902d in FIG. 9d, a combine markup element may be a parent markup language. FIG. 9d illustrates that a combine markup element may be included in a parent markup element. A parent markup element may multiple child markup elements. More than one child element may identify a command that may be identified in a request message. The combine markup element may be defined for and/or otherwise indicating that a command in each of the more than one child elements has a corresponding combinable command response.

Returning to FIG. 2b, block 264 illustrates that the method yet further includes sending a second request message identifying a second command. Accordingly, a system for processing a combined command response based on a markup element includes means for sending a second request message identifying a second command. For example, as illustrated in FIG. 3b, request-out component 362 is configured for sending a second request message identifying a second command. FIG. 4 illustrates request-out component 462 as an adaptation of and/or analog of request-out component 362 in FIG. 3b. One or more request-out components 462 operate in execution environment 402.

FIG. 8 illustrates user agent node 602 in the role of a user agent sending a second command identified second HTTP request message 810 received by server node 604. Second HTTP request message 810 includes second command information identifying a second command for performing by server node 604.

Returning to FIG. 2a, block 254 illustrates that the method additionally includes receiving a second request message identifying a second command. Accordingly, a system for processing a combined command response based on a markup element includes means for receiving a second request message identifying a second command. For example, as illustrated in FIG. 3a, request-in component 352 is configured for receiving a second request message identifying a second command. FIG. 5 illustrates request-in component 552 as an adaptation of and/or analog of request-in component 552 in FIG. 3a.

In one aspect, first request message 808 may include first command information identifying the first command. The first command information may be based on the first resource. For example, as described above the first command information may be based on information included in and/or otherwise associated with a combine markup element. In another aspect, second request message 810 may include second command information identifying the second command. The second command information may be based on the first resource. For example, as described above the second command information may be based on information included in and/or otherwise associated with a combine markup element. Thus, user agent node 602 may send first request message 808 for receiving by server node 904 where first request message 808 includes first command information, based on the first resource sent in resource send message 806. Second request message 810 may be generated and sent analogously.

Returning to FIG. 2a, block 256 illustrates that the method additionally includes determining that a first command response to the first command is combinable based on the first combine-request. Accordingly, a system for processing a combined command response based on a markup element includes means for determining that a first command response to the first command is combinable based on the first combine-request. For example, as illustrated in FIG. 3a, combine director component 352 is configured for determining that a first command response to the first command is combinable based on the first combine-request.

First request message 808 includes combine-request information. In one aspect, second request message may not include combine-request information. In another aspect, second request message may include combine-request information based on a combine markup element sent to user agent node 602. User agent node 602 may send first request message 808 including the first combine-request information based on the first combine markup element. Combine-request information included in a request message identifying a command may be included in the request message for determining that a command response to the command is combinable. When a request message includes command information based on a resource and includes combine-request information based on a combine markup element in the resource, the combine-request information may be sent by the user agent node 602 and received by the server node 604 for determining that the command response for the command is combinable by combine director component 554 in FIG. 5.

For example, in response to a user input selecting the link identified by anchor tag 904a in the resource sent to user agent node 602 in resource send message 806, a UI element handler component 416 for corresponding to a visual representation of the link may invoke content manager component 412 to send first request message 808 including first HTTP request 1000a. When processed by combine director component 554 in web application 504 in FIG. 5, multipart/combined MIME type 1008a may indicate to combine director component 554 that the first command identified in first HTTP request 1000a has a combinable command response.

In an aspect, combine-request information may identify a combine-request condition for evaluating by a server node and/or a combine-request condition may otherwise be evaluated based on combine-request information. For example, a combine-request condition may identify a temporal condition for evaluating by a server node. First response generator component 530.1 in FIG. 5 may receive combine-request information for processing along with command response information received from one or more command handler components 516 in processing the first command identified in a received first request message 808. The combine-request information may identify a duration of time for processing and responding to the command received relative to processing and responding to the second command as determined by second response generator component 530.2. If the first command response can be generated within a specified duration of time that the second command response can be generated, a combine-request condition based on the duration identified in the combine-request information is met according to an aspect. In response to determining that the combine-request condition is met, first response generator component 530.1 and/or second response generator component 530.2 may determine that the first command response and/or the second command response is combinable.

In another example, combine-request information processed by combine director component 554 in FIG. 5 may identify a duration of time for processing and responding to a command received in a request message. Combine markup element 902d in FIG. 9d includes responsemax attribute 906d set to a value of “10 s” for ten seconds. When a command sent by a user agent node in a request message is received by a server node, the server node may determine the command is combinable based on determining that that processing time meets or exceeds the ten seconds specified by the condition. If the condition is met combine director component 554 may determine that the command is combinable. In another aspect, a command response is processed within a specified duration; combine director component 554 may determine a combine-condition is met.

A combine-request condition may be based on a count identified in combine-request information. In FIG. 4, content manager component 414 may identify a count, such as ‘2’. The combine-request information may be received in browser 404 configuration, in a web page markup language element, and/or in metadata for a presented media item too name a few examples. The count may be included in combine-request information sent in a request message by request-out component 462 to web application 504 in FIG. 5. Response generator component 530 may identify combinable commands based on the count. For example, response generator component 530 may determine that command responses to send to the user agent may be combined in pairs in combined response messages as command responses are generated by response generator component(s) 530. Alternatively or additionally, combine-request information identifying a count, a duration of time, and the like may be accessed as configuration data for web application 504 instead of or in addition to receiving combine-request information from a user agent node. Sending the combined response message 814 may include sending the combined response message in response to determining that the second command response is combinable.

A command may be determined to be combinable based on determining that a resource for performing the command is unavailable. A web page presented to a user by presentation controller component 418 in FIG. 4 may indicate that a document is being edited by another user. A UI element handler component 416 may detect a user input for sending a request message including a command for accessing the document and including combine-request information. The combine-request information, when processed by a response generator component 530 in FIG. 5, may indicate the command response to the user's command is combinable.

Determining that command response is combinable may be based on determining that another command response is combinable. For example, combine director component 554 may determine that a first available command response is combinable with a command response already determined to be combinable. The second command response for the second command identified in second request message 810 may be determined to be combinable based on combine director component 554 determining that the first command response is combinable. Alternatively or additionally, combine director component 554 may determine that a command response is combinable if its request message matches the request message of a combinable command response according to some criterion. In one aspect, HTTP method tokens for the message-requests must match.

Second request message 810 may include second combine-request information based on a second combine markup element, which may be included in the first resource or in a second resource. For example, second request message 810 may be sent by user agent node 602 in response to receiving a second resource from server node 604. The second resource may include a second combine markup element and may identify the second command. User agent node 602 may send second request message 810, including second command information based on the second resource and including the second combine-request information based on the second combine markup element. The second combine-request information may be received in the second request message 810 by server node 604 for determining that the second command response for the second command is combinable based on the second combine-request information. For example, second HTTP request 1000b may be exchanged between browser 404 in FIG. 4 and web application 504 in FIG. 5 based on markup 900b included in a second resource sent to user agent node 602 by server node 604. MIME type identifier 1008b may be included in second HTTP request 1000b based on combine markup element 902b.

In a further aspect, a command, having a combinable command response, may be a command for which processing may be deferred by a server. Such a command may be performed and/or its combinable command response may be generated, in response to determining that another command response is combinable and the command responses may be combined in a combined response message. A determination to defer processing of command and to process the command in response to determining that a response message is combinable may be performed by combine director component 554 in FIG. 5 interoperating with one or more command handler components 516 for processing the particular command.

Combine director component 554 in FIG. 5 may be invoked to determine whether a command response for a command identified in a request message is combinable before invoking a command handler component 516, during processing of an operation included in performing the command by a command handler component 516, and/or after processing of the command by a command handler component 516. Combine director component 554 may be invoked in response to receiving and/or otherwise detecting combine-request information indicating a command identified in a received request message has a combinable command response. Combine-request information may be received and/or otherwise detected in a variety of ways in various aspects described below.

In an aspect, a request message and response message pair may be formatted and exchanged according to the HTTP protocol. Combine-request information may be included in and/or otherwise identified based on an HTTP request in an HTTP request line, an HTTP general header, an HTTP request header, an HTTP entity header, and/or an HTTP entity that include an HTTP representation as illustrated in FIG. 10a, FIG. 10b, and FIG. 11a and described above.

Combine-request information received in a request message by web application 504 may be provided to combine director component 554 via request-in component 552, controller component 512, a command handler component 516, a response generator component 530, and/or other component(s) included in processing the request message. Some or all of the combine-request information may be included in and/or otherwise identified by a combine cookie defined to include at least portion of the combine-request information and included in the request message. FIG. 11a illustrates exemplary combine cookie 1108a.

Combine-request information may be included in and/or otherwise generated based on a combine markup element. A markup language may define markup elements including tags, attributes, and attribute values. A combine markup element, in various aspects may be include and/or may be included in a tag, an attribute, and/or an attribute value. A combine markup element may be defined in a markup language for determining that a response message is combinable.

Combine-request information may identify a MIME type defined for indicating that a command response is combinable. A server node may determine that a command identified in a request message has a combinable command response based on the MIME type identifier. First HTTP request 1000a in FIG. 10a includes a multipart/combined MIME type identifier 1008a. “Multipart/combined” may be defined to indicate that a command response to the command identified in HTTP request 1000a sent by a user agent node may be included in a combined HTTP response sent to the user agent node. In FIG. 4, a text/html content handler component 414 may instruct content manager component to send first HTTP request 808 in FIG. 8 including a “multipart/combined” MIME type identifier 1008a in an HTTP ACCEPT header as illustrated in FIG. 10a to indicate the first command identified in first HTTP request 1000a has a combinable command response. In FIG. 5, combine director component 554 interoperating with controller component 512 may detect MIME type identifier 1008a, directly and/or indirectly, and determine the first command in first HTTP request 1000a has a combinable command response.

A script included in web application agent 406 may be configured to include combine-request information in a request message based on a combine markup element included in a markup language resource including and/or otherwise associated with the script. A request message may be sent by and/or in response to executing the script.

Combine-request information may instruct and/or otherwise cause a server to queue and/or cache a command identified in a received request message. A server may queue and/or cache a combinable command until a combine-condition is met. Combine director component 554 may manage a command queue and/or list. Combine director component 554 may be configured to process a command in a list or queue when resource(s) required for performing the command are available.

A first command handler component 516 may be invoked by controller component 512 for performing some or all of the processing for the first command identified by the first command information in first request message 808. Processing of a command, such as the first command, may generate and/or otherwise identify a result or command response. For first request message 808, a first command response and/or data for the first command response may be generated by first command handler component 516. A command response or a portion of a command response may include and/or provide access to any valid HTTP entity and/or HTTP representation such as hypertext markup language (HTML) and/or markup language, a scripting language, byte code, image data, audio data, and machine code.

Returning to FIG. 2a, block 258 illustrates that the method additionally includes sending, in response to determining that the first command response is combinable, a combined response message including the first command response, in response to the first command, and including a second command response, in response to the second command. Accordingly, a system for processing a combined command response based on a markup element includes means for sending, in response to determining that the first command response is combinable, a combined response message including the first command response, in response to the first command, and including a second command response, in response to the second command. For example, as illustrated in FIG. 3a, a response-out component 356 is configured for sending, in response to determining that the first command response is combinable, a combined response message including the first command response, in response to the first command, and including a second command response, in response to the second command. FIG. 5 illustrates response-out component 556 as an adaptation of and/or analog of response-out component 356 in FIG. 3a. One or more response-out components 566 operate in execution environment 502.

FIG. 8 illustrates server node 604 sending a combined response message 814 to user agent node 602.

In FIG. 5, the first command response to the first command identified by first request message 808 may be generated by a response generator component 530 interoperating with a command handler component 516. The first command response may be provided to response-out component 556 as indicated by combine director component 554 for generating a combined response message. The second command response to the second command identified in second request message 810 may also be provided to response-out component 556. Response-out component 556 in FIG. 5 may interoperate with network stack 508 and/or HTTP layer 510 to send a command response in a response message. Some or all of the response message may be generated by response-out component 556. In an aspect, a response-out component 556 may provide command response information to network application platform 506 and/or HTTP layer 510 to include in a command response in a response message generated by controller component 512, network application platform 506, and/or HTTP layer 510.

Response-out component 556 may generate and/or otherwise transform first command response information into one or more message entities, such as HTTP entities and/or HTTP representations to include in combined response message 814. Second command response information may be processed analogously for including in combined response message 814. Response-out component 556 may send combined response message 814 rather than send a first response message for the first request message 808 and rather than send a second response message to second request message 810.

Returning to FIG. 2b, block 266 illustrates that the method additionally includes receiving, in response to sending the first combine-request information, a combined response message including a first command response, in response to the first command, and including a second command response, in response to the second command. Accordingly, a system for processing a combined command response based on a markup element includes means for receiving, in response to sending the first combine-request information, a combined response message including a first command response, in response to the first command, and including a second command response, in response to the second command. For example, as illustrated in FIG. 3b, a combined response component 364 is configured for receiving, in response to sending the first combine-request information, a combined response message including a first command response, in response to the first command, and including a second command response, in response to the second command.

FIG. 4 illustrates combined response component 464 as an adaptation of and/or analog of combined response component 364 in FIG. 3b. One or more combined response components 464 operate in execution environment 402.

Combine-response information may be sent in a combined response message to a user agent node for determining that the response message is a combined response message including multiple combined command responses and/or for identifying at least one of the first command response and the second command response based on the combine-response information. In FIG. 4, response-in component 430 may receive combined response message 814 as described above. Response-in component 430 may provide some or all of combined response message 814 and/or information based on combined response message 814 to combined response component 464. Combined response component 464 may determine that combined response message 814 is a combined response message and locate the first command response and the second command response in combined response message 814.

The first command response and the second command response may include and/or otherwise provide access to data in one or more representations including hypertext markup language (HTML) and/or markup language, a scripting language, byte code, image data, audio data, and/or machine code.

A user agent node may determine a received response message is combined based on receiving combine-response information for determining whether a combined-condition condition is met. Combine-response information may at least partially include and/or otherwise identify a combined-condition.

A server node may include and a user agent node may detect combine-response information in an HTTP response message, to an HTTP request message identifying a command with a corresponding combinable command response, in an HTTP response line, an HTTP general header, an HTTP response header, an HTTP entity header, and/or an HTTP entity that may include an HTTP representation. Some or all of the combine-response information may be included in a combine header defined to include at least a portion of the combine-response information. The combine-response information may include a MIME type identifier defined to indicate that response message is a combined response message and/or for locating a command response in a combined response message. FIG. 11c illustrates status code 1102c as a combined status code for combined HTTP response 1100c. FIG. 11c also illustrates first combine entity header 1104c and second combine entity header 1106c identifying the first command response 1108c in HTTP entity 1110c and the second command response 1112c in HTTP entity 1114c, respectively. The combine entity headers further identify combined HTTP response 1100c as a combined response message. Note that combine cookie 1116c alternatively or additionally identifies first command response base on matching the correlator specified with the correlator specified in first HTTP request 1100a. Combined HTTP response 1000c in FIG. 10c includes multipart/combined MIME type identifier 1014c to indicate that combined HTTP response 814 is combined and includes combined command responses illustrated in HTTP entity 1006c and in HTTP entity 1010c included in combined HTTP response 1000c in the order in which the corresponding commands were sent to server node 604.

Combine-response information may include and/or otherwise identify a combined matching criterion for determining whether a combined-condition is met. For example, a combined matching criterion may include a combined response message correlator identifying a location in a response message for identifying a combined command response and/or may include a symbolic identifier for matching to identify a combined command response. Second HTTP request 1100b in FIG. 11b illustrates a correlator in combine header 1110b. Combine director component 554 may instruct response-out component 556 to include combine header 1110b and/or combine cookie 1108b in combined HTTP response 1100c in FIG. 11c in an entity header associated with the second command response. Combined HTTP response 1100c in FIG. 11c may be sent in combined response message 814 in FIG. 8. The correlator in the various aspects described and/or illustrated may be included in combine-request information for determining whether a combined condition which is met by detecting matching correlators.

FIG. 10c illustrates exemplary combined HTTP response 1000c sent by server node 604 and received by user agent node 602. In FIG. 5 combine director component 554 operating in server node 604 may communicate with one or more response generator components 530 to direct first command response information and second command response information to response-out component 556 for generating and/or providing for generating combined HTTP response 1000c. The first command response is illustrated by first representation 1004c in first entity 1006c. The second command response is illustrated by second representation 1008c included in second entity 1010c.

Status code 1012c is included as a combined status code for the included command responses. In another aspect, a separate command response status codes may be provided in a combined HTTP response, for example as an entity header in first entity 1006c for the first command response. Response-out component 556 may instruct controller component 512 to send combined response message 814 as it sends other response messages described above.

In response to performing the command, command handler component 516 may notify combine director component 554 to generate a combined response message for sending the first and second command responses to browser 404 that sent first request message 808 and second request message 810 identifying the first and second commands, respectively. Combine director component 554 may instruct response-out component 556 to generate a combined response message based on a count of combinable command responses ready for transmitting, for example, “attachcond” attribute 908a in FIG. 9a may configure combine director component 554 to generate a combined response message based on a temporal condition. Combine director component 554 may interoperate with a command handler component 516 for a command and with a response generator component 530 to send whatever combinable command responses are available for returning next.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more instruction-processing units, or by a combination of both. The description herein of any sequence of actions is not intended to imply that the specific order described for performing that sequence must be followed.

Moreover, the methods described herein may be embodied in executable instructions stored in a computer readable medium for use by or in connection with an instruction execution machine, system, apparatus, or device, such as a computer-based or processor-containing machine, system, apparatus, or device. As used here, a “computer readable medium” may include one or more of any suitable media for storing the executable instructions of a computer program in one or more of an electronic, magnetic, optical, electromagnetic, and infrared form, such that the instruction execution machine, system, apparatus, or device may read (or fetch) the instructions from the computer readable medium and execute the instructions for carrying out the described methods. A non-exhaustive list of conventional exemplary computer readable media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating any non-claimed element is essential to the practice of the subject matter as claimed.

I claim:

1. A method for processing a combined command response based on a markup element, the method comprising:
sending, via a network to a user agent node, a first resource including a first combine markup element defined for identifying first combine-request information for a first command identified based on the first resource;
receiving, in response to sending the first resource, the first combine-request information in a first request message identifying the first command;
receiving a second request message identifying a second command;
determining that a first command response to the first command is combinable based on the first combine-request information; and
sending, in response to determining that the first command response is combinable, a combined response message including the first command response, in response to the first command, and including a second command response, in response to the second command.

2. The method of claim 1 wherein the first combine markup element at least one of is included in and includes a hyperlink markup element, a form markup element, and an event markup element; and the first command is identified based on at least one of the hyperlink markup element, the form markup element, and the event markup element.

3. The method of claim 1 wherein the first combine-request information identifies at least one of a MIME type defined for indicating the first command response is combinable and an HTTP method token defined to indicate that the first command response is combinable.

4. The method of claim 1 further comprising:
receiving a third request message, from the user agent node, identifying a third command;
determining that a third command response to the third command is not combinable; and
sending a third response message to the third request message including the third command response at least partially generated while processing at least one of the first command and the second command, and not including another command response based on determining that the third command response is not combinable.

5. The method of claim 1 further comprising sending to the user agent a second resource for identifying the second command and including a second combine markup element identifying second combine-request information defined for determining that the second command response is combinable wherein the second request message is received in response to sending the second resource.

6. The method of claim 5 wherein the combined response message is sent in response to determining that the second command response is combinable.

7. The method of claim 6 further includes at least one of performing the first command and the second command, in response to determining that a second combine-request condition is met based on the second combine-request information.

8. The method of claim 1 wherein sending the combined response message comprises:
determining that the second command response is combinable in response to determining that the first command response is combinable; and
sending the combined response message in response to determining that the second command response is combinable.

9. The method of claim 1 wherein sending the combined response message includes sending combine-response information in the combined response message.

10. A method for processing a combined command response based on a markup element, the method comprising:
receiving, via a network from a server node, a first resource including a first combine markup element defined for identifying first combine-request information for a first command identified based on the first resource;
sending, in response to receiving the first resource, the first combine-request information in a first request message identifying the first command;
sending a second request message identifying a second command; and
receiving, in response to sending the first combine-request information, a combined response message including a first command response, in response to the first command, and including a second command response, in response to the second command.

11. The method of claim 10 wherein at least one of the first resource and the first combine markup element includes representation information for presenting a user detectable representation of the first resource by the user agent node via an output device.

12. The method of claim 10 wherein the first combine markup element at least one of is included in and includes a hyperlink markup element, a form markup element, and an event markup element; and the first command is identified based on at least one of the hyperlink markup element, the form markup element, and the event markup element.

13. The method of claim 10 wherein the first combine-request information identifies a MIME type defined for indicating the first command response is combinable and an HTTP method token defined to indicate that the first command response is combinable.

14. The method of claim 10 wherein sending the second request message comprises:
receiving from the server a second resource for identifying the second command and including a second combine markup element identifying second-combine request information defined to indicate that the second command response is combinable wherein the second request message is received in response to sending the second resource; and
sending the second request message including the second combine-request information based on second combine markup element.

15. The method of claim 10 wherein receiving the combined response message further comprises:
detecting combine-response information in the combined response message; and
identifying at least one of the first command response and the second command response based on the combine-response information.

16. A system for processing a combined command response based on a markup element, the system comprising:
an execution environment including an instruction processing unit configured to process an instruction included in at least one of a resource generator component, a request-in component, a combine director component, and a response-out component;
the resource generator component configured for sending, via a network to a user agent node, a first resource including a first combine markup element defined for identifying first combine-request information for a first command identified based on the first resource;
the request-in component configured for receiving, in response to sending the first resource, the first combine-request information in a first request message identifying the first command;
the request-in component configured for receiving a second request message identifying a second command;
the combine director component configured for determining that a first command response to the first command is combinable based on the first combine-request; and
the response-out component configured for sending, in response to determining that the first command response is combinable, a combined response message including the first command response, in response to the first command, and including a second command response, in response to the second command.

17. A system for processing a combined command response based on a markup element, the system comprising:
an execution environment including an instruction processing unit configured to process an instruction included in at least one of a markup content handler component, a request-out component, and a combined response component;
the markup content handler component configured for receiving, via a network from a server node, a first resource including a first combine markup element defined for identifying first combine-request information for a first command identified based on the first resource;
the request-out component configured for sending, in response to receiving the first resource, the first combine-request information in a first request message identifying the first command;
the request-out component configured for sending a second request message identifying a second command; and
the combined response component configured for receiving, in response to sending the first combine-request information, a combined response message including a first command response, in response to the first command, and including a second command response, in response to the second command.

18. A computer readable medium embodying a computer program, executable by a machine, for processing a combined command response based on a markup element, the computer program comprising executable instructions for:
sending, via a network to a user agent node, a first resource including a first combine markup element defined for identifying first combine-request information for a first command identified based on the first resource;
receiving, in response to sending the first resource, the first combine-request information in a first request message identifying the first command;
receiving a second request message identifying a second command;
determining that a first command response to the first command is combinable based on the first combine-request; and
sending, in response to determining that the first command response is combinable, a combined response message including the first command response, in response to the first command, and including a second command response, in response to the second command.

19. A computer readable medium embodying a computer program, executable by a machine, for processing a combined command response based on a markup element, the computer program comprising executable instructions for:
receiving, via a network from a server node, a first resource including a first combine markup element defined for identifying first combine-request information for a first command identified based on the first resource;
sending, in response to receiving the first resource, the first combine-request information in a first request message identifying the first command;
sending a second request message identifying a second command; and
receiving, in response to sending the first combine-request information, a combined response message including a first command response, in response to the first command, and including a second command response, in response to the second command.
